(19) United States
(12) Patent Application Publication
(10) Pub. No.: US 2025/0256233 A1
(43) Pub. Date: Aug. 14, 2025

(54) BAG FILTER AND OPERATION METHOD TO MINIMIZE CLOGGING DUE TO MOISTURE

(71) Applicant: KOREA INSTITUTE OF ENERGY RESEARCH, Daejeon (KR)

(72) Inventors: Ho-Jung Ryu, Daejeon (KR); Byung Wook Hwang, Daejeon (KR); Yooseob Won, Daejeon (KR); Daewook Kim, Daejeon (KR); Jae Young Kim, Daejeon (KR); Hana Kim, Daejeon (KR); Yu Jin Choi, Daejeon (KR); Sung-ho Jo, Daejeon (KR); Dal-hee Bae, Sejong-si (KR); Seung-yong Lee, Daejeon (KR)

(73) Assignee: KOREA INSTITUTE OF ENERGY RESEARCH, Daejeon (KR)

(21) Appl. No.: 18/742,436

(22) Filed: Jun. 13, 2024

(30) Foreign Application Priority Data
Feb. 8, 2024 (KR) 10-2024-0019299

(51) Int. Cl. B01D 46/04; B01D 46/42; B01D 46/44; B01D 46/46; B01D 46/48; B01D 46/58

(52) U.S. Cl. CPC B01D 46/04; B01D 46/4272; B01D 46/448; B01D 46/46; B01D 46/48; B01D 46/58

(57) ABSTRACT

The present disclosure relates to a bag filter system and operation method thereof to minimize clogging due to moisture, particularly to a bag filter system to minimize clogging due to moisture which includes a pulsing unit that supplies high-pressure compressed gases into an inner filter bag when dedusting the inner filter bag; a pulsing control portion that controls injection duration and cycles of compressed gases by the pulsing unit; a temperature sensor that measures temperature inside a main body of the bag filter; and a humidity sensor that measures humidity inside the main body of the bag filter. The pulsing control portion regulates the injection duration and cycle based on temperature values and humidity values measured in the temperature sensor and the humidity sensor, respectively.

### CORSS-REFERENCE TO RELATED APPLICATIONS

This application claims priority to and the benefit of Korea Patent Application No. 10-2024-0019299 filed in the Korean Intellectual Property Office on Feb. 8, 2024, the contents of which are incorporated herein by reference in their entirety.

### BACKGROUND

### Technical Field

The present disclosure relates to a bag filter system and operation method thereof to minimize clogging due to moisture.

### Related Art

FIG. 1 is a schematic view of the conventional bag filter system. As shown in FIG. 1, a bag filter refers to a type of filtration dust collector that employs a filtering mechanism to capture dust or particulates present in exhaust gases.

Depending on the selection of filter (filter cloth), the bag filter can be used on exhaust gases of a wide range of temperatures and compositions, and also offers several advantages that capture submicron dust smaller than 1 micrometer, which cannot be captured by cyclones.

After injecting dust-containing gases into the bag filter, they are filtered through a filter bag, allowing only clean gases to be discharged. When a large amount of dust adheres to the surface of the filter bag, the dust collection performance decreases, resistance to gas flow increases, and then fan resistance increases. Therefore, the adhered dust is necessarily removed. This is accomplished by injecting high-pressure pulsing gases (pulsing jet) inside the filter bag periodically.

The injection of high-pressure pulsing gases can be controlled by a pulsing timer. A method is commonly used to control the duration of high-pressure gas injection into each filter bag and the time interval (cycle) between these injections.

The material of filter bags can be selected according to characteristics of the gas or dust, and various materials, such as polyester fibers, heat-resistant nylon, fiberglass, Teflone fibers, and acrylic fibers, can be used.

On the other hand, filter bags are considered consumables and require periodical replacement since dust can leak if the filter is damaged. However, the lifespan of filter bags varies depending on their application, dust type, operating conditions, and continuous operating time, making it difficult to determine the exact replacement interval. In recent years, to address these issues, dust meters (dust concentration measurement meter) have been installed to monitor dust leakage in real-time. This allows filter bag replacement when dust leakage exceeds normal levels.

A valve may be installed at the bottom of a dust discharge pipe under the bag filter, and a conveyor may be installed at the bottom of the valve to automatically transport and discharge dust (not illustrated).

When using bag filters as filtration dust collectors, if moisture is contained in the gas-dust mixture introduced into the bag filter, the dust adheres to the filter bag due to the moisture. Additional dust adheres to the already-adhered dust, causing the filter bag to become clogged. In severe cases, the dust forms lumpy attachments. Alternatively, due to the gravity, these lumpy attachments detach and fall to the bottom of the bag filter and form sticky dust lumps around a dust outlet at the bottom of the bag filter, clogging the outlet and occasionally preventing the removal of collected dust.

Further, even when applying high-pressure pulses, the dust adhered to the filter bag hinders dedusting in the filter bag. This increases the pressure difference across the bag filter and disrupts the operation of the upstream system of the bag filter. The increase in pressure difference across the bag filter leads to an increase in fan resistance, which may strain a blower (or fan, compressor, etc.) used to introduce gases and dust into the bag filter.

Additionally, dust collection efficiency becomes lowered, and frequent filter bag replacement is required after short-term use due to contamination and weight-induced damage from the adhered dust. This significantly reduces economic efficiency.

Further, during the process of discharging moisture-laden dust accumulated at the bottom of the bag filter using a pulsing jet cleaning mechanism, additional dust may adhere to the filter bag, potentially clogging the dust outlet or other discharge device.

On the other hand, a method may be employed to prevent moisture or moisture-induced sticky dust from adhering to the filter bag. This method also increases pulsing duration of pulsing gases while shortening pulsing cycle to remove any adhered moisture or dust. However, there are drawbacks that increase costs associated with supplying pulsing gases and result in reduced filter bag durability.

Various approaches have been explored to address these issues. A patent (Korean patent laid-open publication No. 10-2004-0027940) has been proposed for a bag filter that utilizes a moisture condenser to remove moisture from the gas introduced into the bag filter and comprises a water-cooled jacket for condensing moisture in the gas passing through the moisture condenser, and a moisture collector for capturing the condensed water or a moisture outlet. However this patent has the drawback that cannot address clogging by dust or particles captured along with the moisture in the moisture collector or the moisture outlet.

A patent (Korean patent laid-open publication No. 10-2011-037835) has been proposed for a bag filter that equipped with a bag filter drying unit to prevent the bag filter from becoming wet with moisture, which reduces dust collection efficiency and increases fan resistance. However, to dry the bag filter, high-temperature gas is required to be injected using a drying fan, heater, and controller while the dust collection system is stopped. Therefore, this patent has the drawback that additional energy is consumed, leading to low economic efficiency. It also has the drawback that the filter bag can be dried only while the bag filter is stopped.

A patent (Korean patent No. 10-232657) has been proposed for a bag filter equipped with a secondary moisture remover for removing moisture (humidity) from compressed air used during the process of cleaning the bag filter. However, this patent relates to the function of removing moisture from the compressed air used during the process of cleaning the bag filter by pulsing. It does not address the removal of moisture contained in the gas-solid mixture introduced into the bag filter or the function of reducing clogging caused by this moisture.

Particularly, if the moisture contained in the gas-dust mixture discharged from the upstream of the bag filter condenses only at low temperature depending on the conditions during start-up and shutdown, it is advantageous to perform separate operations only when dust-containing gas has a low temperature or high humidity. This avoids the need for continuous moisture removal or heating, as required in the aforementioned patents.

For instance, when using high-temperature exhaust gases from fuel combustion to preheat the upstream system of a bag filter, moisture generated during the fuel combustion process may be present. As the temperature of the gas decreases during the process of introducing gas into the filter bag after preheating the upstream system, the moisture contained in the introduced gas condenses, potentially causing filter bag clogging. As another example, if the upstream system of a bag filter is a fuel combustion system, when low-temperature gases are introduced into the bag filter during the start-up and shutdown processes of the combustion system, or when the temperature decreases while the introduced gas passes through the bag filter, moisture condensation may lead to filter bag clogging. In such cases, it is possible to facilitate the operation of the bag filter by any method for selectively changing operation method of the bag filter or removing dust adhered to the filter bag due to moisture only when the temperature of gases introduced into the bag filter is low or during the start-up and shutdown processes.

### RELATED ART DOCUMENT

### Patent Document

(Patent Document 1) Korean Patent No. 10-1245346
(Patent Document 2) Korean Patent No. 10-2540225
(Patent Document 3) Korean Patent No. 10-2326757
(Patent Document 4) Korean Patent No. 10-0529054

### DETAILED DESCRIPTION

### Technical Problem

Therefore, the present disclosure is contrived to address conventional issues as described above. According to an embodiment of the present disclosure, it aims to provide a bag filter system and operation method thereof to minimize clogging due to moisture, which may fundamentally minimize filter bag clogging through the control of the pulsing timer in response to moisture condensation and dust adhesion potentially caused by decreases in the temperature or increases in humidity of a gas-dust mixture introduced into the bag filter.

According to an embodiment of the present disclosure, it aims to provide a bag filter system and operation method thereof to minimize clogging due to moisture, which may increase pulsing duration continuously to prevent filter bag clogging due to moisture, reduce costs associated with supplying pulsing gases and result in reduced filter bag durability compared to conventional methods to shorten pulsing cycles, and reduce filter bag damage.

According to an embodiment of the present disclosure, it aims to provide a bag filter system and operation method thereof to minimize clogging due to moisture, which may reduce inner filter bag clogging by introducing a portion of the gas flow passing through the inner bag when the temperature of a gas-dust mixture introduced into the filter bag decreases or its humidity increases.

According to an embodiment of the present disclosure, when the lower filter bag become clogged due to moisture condensation and dust adhesion, it is easily cleaned or replaced in a short time using connectors installed to the lower filter bag. Therefore, the present disclosure aims to provide a bag filter system and operation method thereof to minimize clogging due to moisture, which may achieve economic benefits by allowing for cleaning or replacement of the lower filter bag instead of shutting down the entire bag filter system, thus ensuring stable operation.

According to an embodiment of the present disclosure, when moisture-laden dust is discharged only during certain periods, such as during preheating, start-up and shutdown, the moisture-laden dust captured in the lower filter bag can be selectively removed when cleaning or replacing the lower filter bag. Therefore, the present disclosure aims to provide a bag filter system and operation method thereof to minimize clogging due to moisture, which may prevent the dust discharge equipment from excessive strain.

Meanwhile, technical objects to be achieved in the present invention are not limited to the aforementioned technical objects, and other technical objects, which are not mentioned above, will be apparently understood to a person having ordinary skill in the art from the following description.

### Technical Solution

According to a first aspect of the present disclosure, it can be achieved by a bag filter system where an inner filter bag is installed inside and dust-containing gas is introduced to remove the dust, particularly by a bag filter system to minimize clogging due to moisture including: a pulsing unit that supplies high-pressure compressed gases into an inner filter bag when dedusting the inner filter bag; a pulsing control portion that controls injection duration and cycles of compressed gases by the pulsing unit; a temperature sensor that measures temperature inside a main body of the bag filter; and a humidity sensor that measures humidity inside the main body of the bag filter. The pulsing control portion regulates the injection duration and cycle based on temperature values and humidity values measured in the temperature sensor and the humidity sensor, respectively.

Further, either when the temperature value falls below a set temperature range or when the humidity value rises above a set humidity value, the pulsing control portion controls the injection duration to increase and the injection cycle to shorten.

Yet further, either when the temperature value rises above a set temperature range or when the humidity value falls below a set humidity value, the pulsing control portion controls the injection duration to shorten and the injection cycle to increase.

Yet further, the bag filter system further including a lower filter bag that is connected to the bottom of a dust discharge end located at the bottom of the main body; a first control valve that is installed at the top of the lower filter bag; and a second control valve that is installed at the bottom of the lower filter bag.

Yet further, for the inner filter bag, gases and dust come into contact from the outside of the inner filter bag. Thus, dust is filtered by the inner filter bag and dust-removed gas moves to the inside of the inner filter bag and then is discharged.

For the lower filter bag, gases and dust are introduced into the inside of the lower filter bag. Thus, dust is filtered by the lower filter bag and the filtered dust then either adheres to the lower filter bag or descends due to gravity and accumulates under the lower filter bag. Then, the dust-removed gas that has passed through the lower filter bag is discharged to the outside of the lower filter bag.

Yet further, the inner filter bag is processed on the outside, and the lower filter bag is processed on the inside.

Yet further, when the first control valve is open and the second control valve is closed, dust-containing gas is introduced into the lower filter bag, is filtered inside, and then is discharged to the outside.

Yet further, either when the temperature value falls below a set temperature range or when the humidity value rises above a set humidity value, the first control valve is open and the second control valve is closed to introduce a portion of gas-dust mixture and collected dust from the inner filter bag into the lower filter bag.

Yet further, an opening ratio of the first control valve is controlled to regulate a flow rate of dedusted gas discharged to the outside of the lower filter bag.

Yet further, when the gas is discharged only to a portion of the outside of the lower filter bag under the condition that the opening ratio of the first control valve is constant or a flow rate of the dedusted gas discharged into the lower filter bag decreases, the first control valve is closed and then the second valve is open to discharge dust accumulated in the lower filter bag.

Yet further, when dust captured in the lower filter bag causes clogging, hindering dust discharge through the second control valve, or clogging of the lower filter bag leads to a sudden decrease in the amount of dedusted gas discharged outside the lower filter bag, requiring the replacement of the lower filter bag, the lower filter bag is separated, cleaned and then reinstalled using a connector with closing the first control valve and the second control valve.

A second aspect of the present disclosure may be achieved by an operation method of a bag filter system according to the aforementioned first aspect of the present disclosure, particularly by an operation method of a bag filter system to minimize clogging due to moisture including steps of: measuring temperatures in real time by a temperature sensor installed inside a main body of a bag filter, and measuring humidity in real time by a humidity sensor installed inside the main body of the filter bag; controlling injection duration to increase and injection cycles to shorten by a pulsing control portion either when the temperature value falls below a set temperature range or when the humidity value rises above a set humidity value; introducing a portion of gas-dust mixture and collected dust from the inner filter bag into the lower filter bag by opening a first control valve and closing a second control valve; and filtering dust by the lower filter bag in which the filtered dust then either adheres to the lower filter bag or descends due to gravity and accumulates under the lower filter bag, and then discharging dust-removed gas that has passed through the lower filter bag to the outside of the lower filter bag.

Further, the operation method of a bag filter system further including further step of: controlling the injection duration to decrease and the injection cycle to increase by the pulsing control portion and closing the first control valve either when the temperature value rises above a set temperature range or when the humidity value rises above a set humidity value.

Yet further, the operation method of a bag filter system further including step of: controlling an opening ratio of the first control valve to adjust a flow rate of dedusted gas discharged to the outside of the lower filter bag.

Yet further, the operation method of a bag filter system further including one selected from steps of: discharging accumulated in the lower filter bag by closing the first control valve and then opening the second control valve when a flow rate of the dedusted gas discharged into the lower filter bag decreases, or the gas is discharged only to a portion of the outside of the lower filter bag; and separating, cleaning and then reinstalling the lower filter bag using a coupling connector with closing the first control valve and the second control valve when the lower filter bag needs to be replaced.

### Advantageous Effects

According to a bag filter system and operation method thereof to minimize clogging due to moisture in accordance of the embodiment of the present disclosure, it is capable of fundamentally minimizing filter bag clogging through the control of the pulsing timer in response to moisture condensation and dust adhesion potentially caused by decreases in the temperature or increases in humidity of a gas-dust mixture introduced into the bag filter.

According to a bag filter system and operation method thereof to minimize clogging due to moisture in accordance of the embodiment of the present disclosure, it is capable of increasing pulsing duration continuously to prevent filter bag clogging due to moisture, reducing costs associated with supplying pulsing gases and result in reduced filter bag durability compared to conventional methods to shorten pulsing cycles, and reducing filter bag damage.

According to a bag filter system and operation method thereof to minimize clogging due to moisture in accordance of the embodiment of the present disclosure, it is capable of reducing inner filter bag clogging by introducing a portion of the gas flow passing through the inner bag when the temperature of a gas-dust mixture introduced into the filter bag decreases or its humidity increases.

According to a bag filter system and operation method thereof to minimize clogging due to moisture in accordance of the embodiment of the present disclosure, it is easily cleaned or replaced in a short time using connectors installed to the lower filter bag, thereby achieving economic benefits by allowing for cleaning or replacement of the lower filter bag instead of shutting down the entire bag filter system, thus ensuring stable operation.

According to a bag filter system and operation method thereof to minimize clogging due to moisture in accordance of the embodiment of the present disclosure, when moisture-laden dust is discharged only during certain periods, such as during preheating, start-up and shutdown, the moisture-laden dust captured in the lower filter bag can be selectively removed when cleaning or replacing the lower filter bag, thereby preventing the dust discharge equipment from excessive strain.

Meanwhile, advantageous effects to be obtained in the present disclosure are not limited to the aforementioned effects, and other effects, which are not mentioned above, will be apparently understood to a person having ordinary skill in the art from the following description.

### BRIEF DESCRIPTION OF THE DRAWINGS

The accompanying drawings of this specification exemplify a preferred embodiment of the present disclosure, the spirit of the present disclosure will be more clearly understood from the following detailed description taken in conjunction with the accompanying drawings, and thus it will be understood that the present disclosure is not limited to only contents illustrated in the accompanying drawings;

FIG. 1 is a schematic view of the conventional bag filter system,

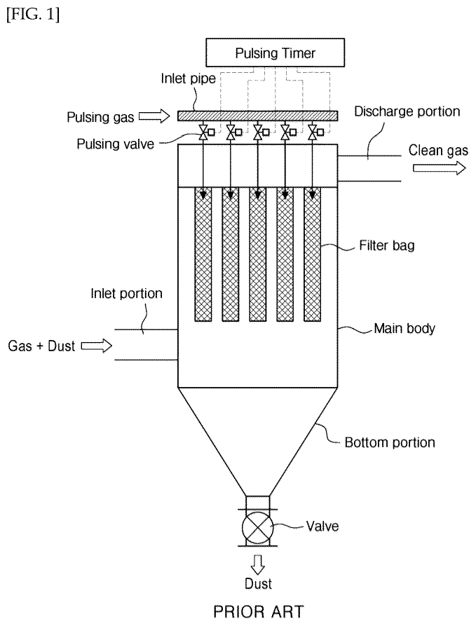

FIG. 2 is a schematic view of a bag filter system to minimize clogging due to moisture according to an embodiment of the present disclosure,

FIG. 3 is a flowchart of an operation method of a bag filter system to minimize clogging due to moisture according to an embodiment of the present disclosure, and

FIG. 4 is a block view showing the signal flow of a control portion according to an embodiment of the present disclosure.

### DETAILED DESCRIPTION

Hereinafter, the aforementioned aims, other aims, features and advantageous effects of the present disclosure will be understood easily referring to preferable embodiments related to the accompanying drawings. However, the present disclosure is not limited to embodiments described in this specification, and may be embodied into other forms. Preferably, the embodiments in this specification are provided in order to allow disclosed contents to be exhaustive and to communicate the concept of the present disclosure to those skilled in the art.

In this specification, when a certain element is placed on another element, this means that it may be formed directly thereon or that the third element may be interposed between them. Further, in the drawings, the thickness of an element may be overstated in order to explain the technical content thereof efficiently.

The embodiments described in this specification will explained with reference to a cross-sectional view and/or a plane view. In the drawings, the thickness of a film and a region may be overstated in order to explain the technical content thereof efficiently. Accordingly, the form of exemplary drawings for a fabrication method and/or an allowable error et cetera may be reformed. Thus, the embodiments according to the present disclosure are not limited to specific forms illustrated herein, but may include variations in the form resulting from the fabrication method. For example, the region illustrated with perpendicular lines may have a form to be rounded or with a predetermined curvature. Thus, regions exemplified in the drawings have attributes, and shapes thereof exemplify specific forms rather than limiting the scope of the present disclosure. In the various embodiments of this specification, terms such as ‘first’ and ‘second’ et cetera are used to describe various elements, but these elements should not be limited to such terms. These terms are merely used to distinguish one element from others. The embodiments explained and exemplified herein may include complementary embodiments thereto.

The terms used in this specification is to explain the embodiments rather than limiting the present disclosure. In this specification, the singular expression includes the plural expression unless specifically stated otherwise. The terms, such as ‘comprise” and/or “comprising” do not preclude the potential existences of one or more elements.

When describing the following specific embodiments, various kinds of specific contents are made up to explain the present disclosure in detail and to help understanding thereof. However, it will be apparent for those who have knowledge to the extent of understanding the present disclosure that the present disclosure can be used without any of these specific contents. In a certain case when describing the present disclosure, the content that is commonly known to the public but is largely irrelevant to the present disclosure is not described in order to avoid confusion.

Hereinafter, described are the configuration and function of a bag filter system to minimize clogging due to moisture according to an embodiment of the present disclosure and an operation method thereof.

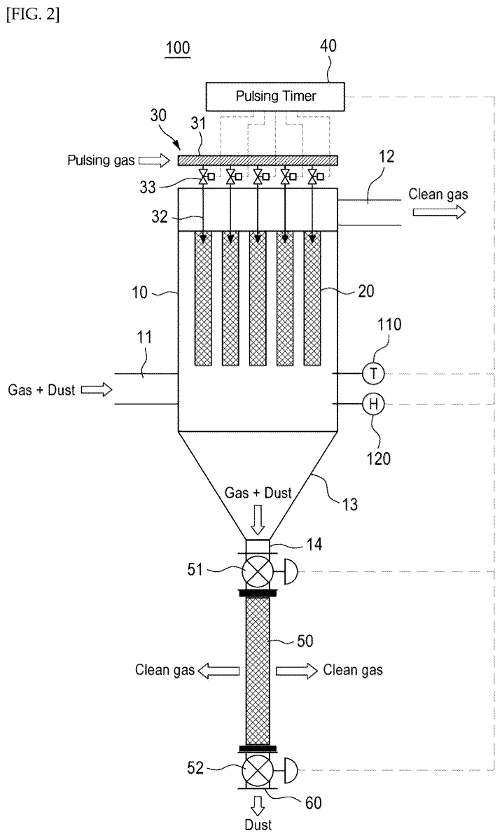

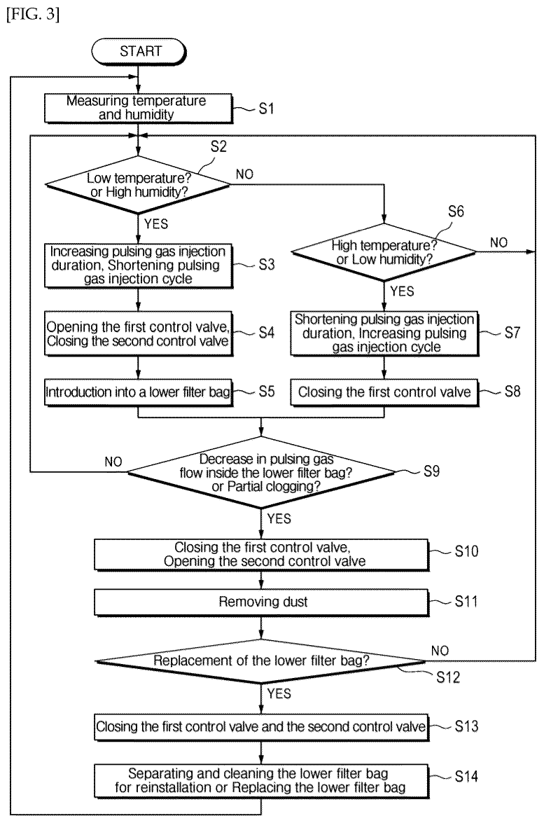

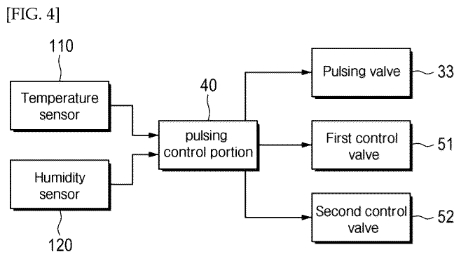

FIG. 2 is a schematic view of a bag filter system to minimize clogging due to moisture according to an embodiment of the present disclosure. FIG. 3 is a flowchart of an operation method of a bag filter system to minimize clogging due to moisture according to an embodiment of the present disclosure. FIG. 4 is a block view showing the signal flow of a control portion according to an embodiment of the present disclosure.

A bag filter main body 10 is provided with an inlet portion 11 and an outlet portion 12 that discharges gas from which dust was removed by an inner filter bag 20.

A filter bag system to minimize clogging due to moisture 100 according to an embodiment of the present disclosure includes an inner filter bag 20 and a pulsing unit 30 that supplies high-pressure compressed gases into the inner filter bag 20 when dedusting. This pulsing unit 30 may include a pulsing gas inlet portion 31 into which pulsing gases are introduced, an injection nozzle 32 that branches off from the pulsing gas inlet portion towards each inner filter bag 20 and injects pulsing gases into the inner filter bag at high pressure, and a pulsing valve 33 that is provided on each side of the injection nozzle 32.

In addition, a pulsing control portion 40 is configured to control the injection duration and cycles of compressed gases provided by the pulsing unit 30.

That is, according to an embodiment of the present disclosure, to minimize filter bag clogging due to moisture condensation, as shown in FIG. 2, a temperature sensor 110 and a humidity sensor 120 are installed inside a filter bag. The temperature sensor 110 and the humidity sensor 120 may be installed at locations that represent the temperature and humidity inside the bag filter main body 10, and multiple sensors may be installed. In addition, for the humidity sensor (120), an absolute humidity sensor or a relative humidity sensor may be installed depending on the characteristics of the system. High-pressure compressed gases are supplied for dedusting caused by the pulsing of the inner filter bag 20. The pulsing control portion 40, which is capable of controlling the injection duration and cycles (intervals) of pulsing gases for each inner filter bag 20, is installed.

In other words, the pulsing control portion 40 controls regulates the injection duration and cycles of pulsing gases based on temperature values and humidity values measured in the temperature sensor 110 and the humidity sensor 120, respectively. More particularly, either when the temperature value falls below a set temperature range, or when the humidity value rises above a set humidity range, the pulsing control portion 40 controls the injection duration to increase and the injection cycle to shorten.

In addition, either when the temperature value rises above a set temperature range, or when the humidity value falls below a set humidity range, the pulsing control portion 40 controls the injection duration to shorten and the injection cycle to increase.

Further, according to an embodiment of the present disclosure, a lower filter bag 50 is connected to the bottom of a dust discharge end 14 located at the bottom of the bag filter main body 10. In addition, a first control valve 51 is provided at the top of the lower filter bag 50, and a second control valve 52 is provided at the bottom of the lower filter bag 50.

In addition, a connector is installed to facilitate the installation and removal of the lower filter bag 50 installed between the first control valve 51 and the second control valve 52.

For the inner filter bag 20 installed inside the bag filter main body 10, gases and dust come into contact from the outside of the inner filter bag 20. Thus, dust is filtered by the inner filter bag 20 and dust-removed gas moves to the inside of the inner filter bag 20 and then is discharged. On the other hand, for the lower filter bag 50 installed at the bottom of a bag filter bottom portion 13, gases and dust are introduced into the inside of the lower filter bag 50. Thus, dust is filtered by the lower filter bag 50 and the filtered dust then either adheres to the lower filter bag 50 or descends due to gravity and accumulates under the lower filter bag 50.

In addition, the dust-removed gas that has passed through the lower filter bag 50 is discharged to the outside of the lower filter bag 50. Accordingly, for the inner filter bag 20 installed inside the bag filter main body 10, when processing (such as water-repellent, oil-repellent, acid/alkali-resistant, anti-static, or flame-retardant treatment) is required to enhance performance, the inner filter bag 20 is processed on the outside. On the other hand, for the lower filter bag 50, it is required that the lower filter bag 50 is processed on the inside. Further, a cartridge-type filter may be used instead of the lower filter bag 50.

Hereinafter, describe is an operation method of a bag filter system to minimize clogging due to moisture according to an embodiment of the present disclosure.

Firstly, temperature and humidity of a gas-dust mixture introduced into an inlet portion 11 are measured in real time using a temperature sensor 110 and a humidity sensor 120 S1.

When the temperature of the gas-dust mixture is low or its humidity is high S2, an inner filter bag 20 is potentially wet due to moisture condensation and dust potentially adheres to the inner filter bag 20. Thus, a pulsing control portion 40 controls pulsing gas injection duration to increase and pulsing cycles to shorten in each inner filter bag 20 S3. This minimizes adhesion of moisture and dust to the inner filter bag 20.

Conversely, when the temperature of the gas-dust mixture is high or its humidity is low S6, the pulsing control portion 40 controls pulsing gas injection duration to shorten and pulsing cycles to increase in each inner filter bag 20 S7.

In addition, when the temperature of the gas-dust mixture is low or its humidity is high, a first control valve 51 is open simultaneously with the operation of the pulsing control portion 40 S4. Thus, a portion of gas-dust mixture and collected dust from the inner filter bag 20 are introduced into a lower filter bag 50 S5. During this time, a second control valve 52 remains closed.

Conversely, when the temperature of the gas-dust mixture is high or its humidity is low, a first control valve 51 is closed S8.

Meanwhile, the first control valve 51 utilizes a control valve that is capable of changing an opening ratio and may change a flow rate of dedusted gas is discharged to the outside of the lower filter bag 50 by changing the opening ratio.

When the gas is discharged only to a portion of the outside of the lower filter bag under the condition that the opening ratio of the first control valve 51 is constant or a flow rate of the dedusted gas discharged into the lower filter bag 50 decreases, the first control valve 51 is closed and then the second valve 52 is open S10, and then dust accumulated in the lower filter bag 50 is discharged and removed through a discharge portion 60 S11.

When dust captured in the lower filter bag 50 causes clogging, hindering dust discharge through the second control valve, 52 or clogging of the lower filter bag 50 leads to a sudden decrease in the amount of dedusted gas discharged outside the lower filter bag 50, requiring the replacement of the lower filter bag 50 S12, the lower filter bag 50 is separated, cleaned and then reinstalled, or replaced using a connector with closing the first control valve 51 and the second control valve 52 S14. Then, the first control valve 51 is open and the aforementioned operations are repeated.

Further, the configuration and method of the embodiments as described above are not restrictively applied to the aforementioned apparatus and method. The whole or part of the respective embodiments may be selectively combined so as to make various modifications of the embodiments.

### FIGURE REFERENCE NUMBERS

10: main body
11: inlet portion
12: outlet portion
13: bottom portion
14: discharge end
20: inner filter bag
30: pulsing unit
31: pulsing gas inlet portion
32: injection nozzle
33: pulsing valve
40: pulsing control portion
50: lower filter bag
51: first control valve
52: second control valve
60: discharge portion
100: bag filter system minimizing clogging due to moisture

1. In a bag filter system where an inner filter bag is installed inside and dust-containing gas is introduced to remove the dust, a bag filter system to minimize clogging due to moisture comprising:
a pulsing unit that supplies high-pressure compressed gases into an inner filter bag when dedusting the inner filter bag;
a pulsing control portion that controls injection duration and cycles of compressed gases by the pulsing unit;
a temperature sensor that measures temperature inside a main body of the bag filter; and
a humidity sensor that measures humidity inside the main body of the bag filter, wherein
the pulsing control portion regulates the injection duration and cycle based on temperature values and humidity values measured in the temperature sensor and the humidity sensor, respectively.

2. The bag filter system to minimize clogging due to moisture of claim 1, wherein
either when the temperature value falls below a set temperature range or when the humidity value rises above a set humidity value,
the pulsing control portion controls the injection duration to increase and the injection cycle to shorten.

3. The bag filter system to minimize clogging due to moisture of claim 2, wherein
either when the temperature value rises above a set temperature range or when the humidity value falls below a set humidity value,
the pulsing control portion controls the injection duration to shorten and the injection cycle to increase.

4. The bag filter system to minimize clogging due to moisture of claim 3, further comprising:
a lower filter bag that is connected to the bottom of a dust discharge end located at the bottom of the main body;
a first control valve that is installed at the top of the lower filter bag; and
a second control valve that is installed at the bottom of the lower filter bag.

5. The bag filter system to minimize clogging due to moisture of claim 4, wherein
for the inner filter bag, gases and dust come into contact from the outside of the inner filter bag. Thus, dust is filtered by the inner filter bag and dust-removed gas moves to the inside of the inner filter bag and then is discharged; and
for the lower filter bag, gases and dust are introduced into the inside of the lower filter bag. Thus, dust is filtered by the lower filter bag and the filtered dust then either adheres to the lower filter bag or descends due to gravity and accumulates under the lower filter bag. Then, the dust-removed gas that has passed through the lower filter bag is discharged to the outside of the lower filter bag.

6. The bag filter system to minimize clogging due to moisture of claim 5, wherein
the inner filter bag is processed on the outside, and the lower filter bag is processed on the inside.

7. The bag filter system to minimize clogging due to moisture of claim 4, wherein
when the first control valve is open and the second control valve is closed, dust-containing gas is introduced into the lower filter bag, is filtered inside, and then is discharged to the outside.

8. The bag filter system to minimize clogging due to moisture of claim 7, wherein
either when the temperature value falls below a set temperature range or when the humidity value rises above a set humidity value,
the first control valve is open and the second control valve is closed to introduce a portion of gas-dust mixture and collected dust from the inner filter bag into the lower filter bag.

9. The bag filter system to minimize clogging due to moisture of claim 8, wherein
an opening ratio of the first control valve is controlled to regulate a flow rate of dedusted gas discharged to the outside of the lower filter bag.

10. The bag filter system to minimize clogging due to moisture of claim 9, wherein
when the gas is discharged only to a portion of the outside of the lower filter bag under the condition that the opening ratio of the first control valve is constant or a flow rate of the dedusted gas discharged into the lower filter bag decreases,
the first control valve is closed and then the second control valve is open to discharge dust accumulated in the lower filter bag.

11. The bag filter system to minimize clogging due to moisture of claim 10, wherein
when dust captured in the lower filter bag causes clogging, hindering dust discharge through the second control valve, or clogging of the lower filter bag leads to a sudden decrease in the amount of dedusted gas discharged outside the lower filter bag, requiring the replacement of the lower filter bag,
the lower filter bag is separated, cleaned and then reinstalled using a connector with closing the first control valve and the second control valve.

12. In an operation method of a bag filter system according to claim 2, an operation method of a bag filter system to minimize clogging due to moisture comprising steps of:
measuring temperatures in real time by a temperature sensor installed inside a main body of a bag filter, and measuring humidity in real time by a humidity sensor installed inside the main body of the filter bag;
controlling injection duration to increase and injection cycles to shorten by a pulsing control portion either when the temperature value falls below a set temperature range or when the humidity value rises above a set humidity value;
introducing a portion of gas-dust mixture and collected dust from the inner filter bag into the lower filter bag by opening a first control valve and closing a second control valve; and
filtering dust by the lower filter bag in which the filtered dust then either adheres to the lower filter bag or descends due to gravity and accumulates under the lower filter bag, and then discharging dust-removed gas that has passed through the lower filter bag to the outside of the lower filter bag.

13. The operation method of a bag filter system to minimize clogging due to moisture of claim 12, further comprising step of:
controlling the injection duration to decrease and the injection cycle to increase by the pulsing control portion and closing the first control valve either when the temperature value rises above a set temperature range or when the humidity value rises above a set humidity value.

14. The operation method of a bag filter system to minimize clogging due to moisture of claim 13, further comprising step of:
controlling an opening ratio of the first control valve to regulate a flow rate of dedusted gas discharged to the outside of the lower filter bag.

15. The operation method of a bag filter system to minimize clogging due to moisture of claim 14, further comprising one selected from steps of:
discharging accumulated in the lower filter bag by closing the first control valve and then closing the second control valve when a flow rate of the dedusted gas discharged into the lower filter bag decreases, or the gas is discharged only to a portion of the outside of the lower filter bag; and
separating, cleaning and then reinstalling the lower filter bag using a connector with closing the first control valve and the second control valve when the lower filter bag needs to be replaced.
